(19) United States
(12) Patent Application Publication
(10) Pub. No.: US 2017/0199586 A1
(43) Pub. Date: Jul. 13, 2017

(54) Gesture control method for interacting with a mobile or wearable device utilizing novel approach to formatting and interpreting orientation data

(71) Applicant: 16Lab Inc., Kamakura (JP)

(72) Inventors: Tõnu SAMUEL, Tallinn (EE); Jan ROD, Singapore (SG); Rafael FERRIN, Tokyo (JP)

(73) Assignee: 16Lab Inc., Kamakura (JP)

(21) Appl. No.: 15/401,358

(22) Filed: Jan. 9, 2017

Related U.S. Application Data
(60) Provisional application No. 62/276,335, filed on Jan. 8, 2016.
(60) Provisional application No. 62/276,668, filed on Jan. 8, 2016.
(60) Provisional application No. 62/276,684, filed on Jan. 8, 2016.

(51) Int. Cl. G06F 3/0346; G06F 3/01

(52) U.S. Cl. CPC G06F 3/0346; G06F 3/017

(57) ABSTRACT

The aim of the present invention is to provide a method to solve the common drift problems and 3D orientation errors related to the use of orientation data of a mobile or wearable device and target system and for using mobile or wearable device as a Human-Machine Interface (HMI) using Inertial Measurement Units (IMUs) and potentially other sensors (for example cameras and markers, radar systems) as input data to convert user's motion into an interaction, a pointer on the screen or a gesture. The contribution of this invention is a solution for well-known problems related to the use of IMUs and motion sensors as input devices for user interaction in general, as well as specific embodiments and application scenarios of these methods where wearable and/or mobile devices are used to control specific interfaces.

### PRIORITY

This application claims priority of U.S. provisional application No. 62/276,335 filed on Jan. 8, 2016, U.S. provisional application No. 62/276,668 filed on Jan. 8, 2016 and U.S. provisional application No. 62/276,684 filed on January 8, the contents of each of which is incorporated herein by reference.

### FIELD OF INVENTION

The present invention relates to the field of Human-Machine Interfaces (HMIs) where user interacts with mobile or wearable devices, specially a use of the orientation and motion data of the device as input for a target system or device or for an Operative System (OS).

### BACKGROUND OF THE INVENTION

Using mobile portable devices as controllers for various target systems that allows users to freely and naturally interact with interfaces on various types or screens, big or small, has been an interest of Human-Computer Interaction research for some time.

Known successful systems use various types of input data based on, for example, optical, radar, and other sensors. Inertial Measurement Units (IMUs) have been also seen as promising technology, however these are prone to various problems that reduce their usefulness for the body motion and position tracking applications.

Rotation, angle or angular speed sensors used in IMUs for different wearable applications, for example head or limb tracking have small error. Error sources may include inaccuracy of moving limbs, sensing errors, timing errors or later errors caused by processing in hardware or software. This error causing problem is called “drift”. Drift is accumulated error which causes deviation of perceived position from actual position in physical space. Known gesture control methods of wearable devices tried different ways to reduce effects of drift, usually improved algorithms, dead reckoning or based on other sensors—GPS, magnetic, light, switches, rotary encoders etc. but this has not sufficiently addressed the needs of applications.

These problems known from prior art can be classified as follows.

Horizontal drift: The horizontal orientation may accumulate drift, especially if the gyroscope is the only sensor and no other sensors is supporting the gyroscope.

Horizontal absolute orientation: Depending on the available sensors on the device, it may be possible to track the changes over the horizontal orientation of a device, but it may be not possible to certainly know if the device is facing north, south, east or west, for example.

User's point of reference: using the device as a pointer, even if the device certainly knows that it is pointing north, it is unknown if the screen where the user is pointing is at the north of the user or at the east.

Angle of the real pointing direction with the expected pointing direction: the user could be using a phone, a finger or the wrist for pointing on a screen, for example, but the real direction in which the device is pointing and the direction in which the user thinks it is pointing doesn't match. The error may be small enough to not to affect the experience of the vertical and horizontal turns while pointing in different directions, but if the user tries to turn around the pointing direction (twisting his hand), the error can be very annoying.

In addition, due to the bones of the limb of the user, the turned angle turned over the pointing direction can be accurate, but the angles of the horizontal and vertical pointing directions will be strongly affected on the process.

In prior art the drift error is also known when a peripheral as input device is a transformation from the physical space where the peripheral is used to the virtual space of the OS commands. In the case of 3D orientation transformations, there are problems like the drift error of integrating gyroscope data, the mismatch of the device orientation with the user intended input orientation, the unknown starting orientation of the device or the unknown relative position of the mobile device (user) with the OS that it is receiving the input data.

Due to the different nature of the different errors and uncertainties that affect the process of using the orientation of a device as input for an OS, it is necessary to define that orientation using a specific set of variables that are differently affected by those errors.

Computers have keyboards with many buttons which makes them rich user interface devices. Virtually endless input combinations are possible to enter if user had tens of buttons available for use. Meanwhile simpler input devices exist—for example computer mouse with very few buttons available. Some input devices, for example wearable rings, bracelets, smartwatches may accept input without pressing any triggers or just having very limited triggers/buttons. However, many of these devices rely on orientation sensing which is prone to error described herein, which hinders their potential to become widespread and go-to technologies challenging the dominance of current peripherals, especially in novel application scenarios, such as big screen controls or smart home appliance controls.

### SUMMARY OF THE INVENTION

The aim of the present invention is to provide a method to solve the mentioned drift problems and 3D orientation errors related to the use of orientation data of a mobile or wearable device and target system and for using mobile or wearable device as a

Human-Machine Interface (HMI) by utilizing Inertial Measurement Unit (IMU) and potentially other sensors (for example cameras and markers, radar systems) as input data to convert user's motion into an interaction, a pointer on the screen or a gesture. The contribution of this invention is a solution for well known problems related to the use of IMUs and motion sensors as input devices for user interaction in general, as well as specific embodiments of these methods where wearable and/or mobile devices are used to control specific interfaces.

Furthermore, this invention provides an instant and easy-to-use gesture control method for interacting with a mobile or wearable device (for example smartphones, remote controls, tablets, wands, etc.), preferably in wearable miniature devices (for example smart jewelries, smart watches, smart wristbands, smart rings, etc) to solve the drift problem.

In order to achieve the aim of the present invention set of initial poses of the user's mobile or wearable device and functionalities of users mobile or wearable device associated to said initial poses are predefined to configure the present gesture control method. Thereafter the initial pose for the desired functionality is adopted and signal of the trigger activation is obtained. The data from at least one sensor is acquired and the first values of the data is used as input data to detect the initial pose. Then the functionality according to the initial pose is determined and if required the sensor data is formatted for corresponding functionality. After this the rest of values of the input data stream according to the corresponding functionality is interpreted to eliminate drift.

The present invention is explained with the following example. In realm of user interface accessible via head or hand, room around user body is not uniform. Some areas are more easy to reach. For example it is easy to move hand with computer mouse left and right within some reasonable limits. Meanwhile it is very uncomfortable to move same mouse in full circle around human body. While theoretically possible, it requires complicated cooperation of both hands, or external aid in form of rotation full body. Similarly it is easy for user to turn head left and right but difficult to look behind without moving other body parts. Therefore it is natural to assume user body used to manipulate user interface has imaginary “comfort window” where moving body part is more natural.

Drift problem in context of comfort window can be easily understood with computer mouse. In limited desk space user still expects to freely move mouse to left if cursor on screen can go left. If mouse hits object as keyboard, user corrects problem by raising mouse and moving it into new location to eliminate drift which has been accumulated.

Instead of doing a general transformation from the XYZ axes of the mobile device to the reference fixed XYZ axes of the user and offer that transformation as standard device orientation data, the present method proposes different ways to use the data from the different sensors in different algorithms, depending on the interaction that the user is doing with the device at each moment. Doing so, the own values of the parameters of each transformation will have a proper physical meaning directly related to the movements that the user is doing and therefore the movements are directly used as input data for the target system or device.

This target system or device is further used to interact with a mobile or wearable device using a stream of sensor data as input data comprises steps of configuration of the user's device comprising
predefining the set of initial poses of the user's device;
predefining the commands and functionalities of user's device associated to said initial poses; drift eliminating comprising
adopting the each predefined initial pose for the desired functionality;
obtaining the signal of trigger activation;
acquiring data from at least one sensor;
using the first values of the sensor data to detect the predefined initial pose;
determining the functionality according to the predefined initial pose;
formatting the sensor data (if required) for said functionality;
interpreting the rest of values of the input data stream according to said functionality.

The nature of the sensor data used in the present invention as input data is for example inertial measurement unit (IMU), camera, linear and/or angular accelerometer, magnetometer, gyroscope, color sensor, electrostatic field sensor, tilt sensor, gps, backlight, clock, battery level, status of a Bluetooth connection or any other quantifiable parameter measuring unit related to the mobile or wearable device use or their combination. The sensor data is generated by the device comprising corresponding sensor or received in any way (from another sensor via wireless or wired communication). In step of configuration of user's device the predefined poses of the user's device are for example the orientation of the device, the movement of the device (for example linear or nonlinear, oscillation or vibration, shaking, uniform or non uniform movement. The predefined functionalities assigned to predefined poses are specific commands to the device. The predefining of the initial poses comprises direct data values (for example battery level, orientation of the device, etc.) and data derived from the direct data values (For example if orientation changes fast the device is being shaken. If GPS changes fast the user of mobile or wearable device is in transportation vehicle, etc.). Therefore, some of the values of an initial pose are direct inputs from the user's device (e.g. orientation, shaking of the device) and other values are circumstantial. The values chosen by the user are the key of the present invention, because the chosen values give the user the ability of selecting an initial pose (shake the device, put it vertical, etc.) before activating the trigger. As the user knows the possible initial poses, the selection of a pose is equivalent to the selection of a command to the device (type this letter, create a mouse pointer on the screen, switch off the TV,). The activation trigger is for example a button on the device, a software function, the starting moment of a data streaming or any other method, function or command initiated by the user, by the device itself or by an external interaction (for example a trigger received wirelessly via RF, sound or light).

The advantage of the present invention is that for many data sources as IMU or color sensors, for example, it is not necessary a previous formatting of the sensor data to be used as part of the initial pose. For example, an accelerometer raw value of acceleration over the X axis will be different depending on the hardware and configuration, but for similar orientations it will have similar values and during a shaking situation will oscillate considerably. Therefore both orientation and stability can be used as initial pose without formatting. Depending on the selected functionality after the initial pose the data could be specifically filtered or formatted for the selected functionality. The drift eliminating from gesture control according to the present invention is explained more precisely in further embodiments.

### BRIEF DESCRIPTION OF THE DRAWINGS

The present invention is explained more precisely with references to the figures added, where

FIG. 1 illustrates the problem known from prior art wherein the user;

FIG. 2 explains Elevation-Heading-Bank coordinates system, also called Tait-Bryan angles, Cardan Angles, Nautical angles or Yaw-Pitch-Roll, which is used in the method according to present invention;

FIG. 3 illustrates some examples of orientations according to the present invention defined by Elevation (1, 2, 3, 4, 5) and Bank (a, b, c);

FIG. 4 illustrates the problem known from prior art;

FIG. 5 to FIG. 7 illustrate the method according to present invention;

FIG. 8 illustrates an alternative embodiment of the present invention, wherein a user uses pencil tool to draw line on screen.

### DETAILED DESCRIPTION OF THE INVENTION

The present gesture control method for interacting with a mobile or wearable device using a stream of sensor data as input data comprises steps of configuration of a user's device and drift eliminating wherein

configuration of the user's device comprising
predefining the set of initial poses of the user's device;
predefining the commands and functionalities of user's device associated to said initial poses;

drift eliminating comprising
adopting the each predefined initial pose for the desired functionality;
obtaining the signal of trigger activation;
acquiring data from at least one sensor;
using the first values of the sensor data to detect the predefined initial pose;
determining the functionality according to the predefined initial pose;
formatting the sensor data (if required) for said functionality;
interpreting the rest of values of the input data stream according to said functionality.

The trigger activation is a function or command (for example physical button, touch sensor, wireless trigger, sound, or light based trigger, orientation or acceleration based trigger, or any other threshold based trigger using various sensors) initiated by device itself or by an external interaction. Acquiring input data comprises numeric values representing quantifiable parameters (for example orientation, acceleration, heading) related to the mobile or wearable device use. The rest of the input data is managed by different functions, by the same function but with different parameters, ignored or managed by any other method.

In an alternative embodiment, the present gesture control method for interacting with a mobile or wearable device using a stream of sensor data as input data comprises steps of
configuration of user's mobile or wearable device;
predefining the set of initial poses of the device;
predefining the functionalities associated to those initial poses;

<Usage>
adopting the initial pose for the desired functionality;
activating the trigger;
acquiring data from the sensors;
using the first values of the data to detect the initial pose;
determining the functionality according to the initial pose;
formatting the data (if required) for that functionality;
interpreting the rest of the input data stream according to that functionality.

In the alternative embodiment, the trigger activation is a function or command initiated by the user; acquiring input data comprises numeric values representing quantifiable parameters related to the mobile device use and the rest of the input data is managed by different functions, by the same function but with different parameters, ignored or managed by any other method.

The nature of the sensor data used in the present invention as input data is for example inertial measurement unit (IMU), camera, linear and/or angular accelerometer, magnetometer, gyroscope, color sensor, electrostatic field sensor, tilt sensor, gps, backlight, clock, battery level, status of a bluetooth connection or any other quantifiable parameter measuring unit related to the mobile or wearable device use or their combination. The sensor data is generated by the device comprising corresponding sensor or received in any way.

In step of configuration of user's device, the predefined poses of the user's device are for example the orientation of the device, the movement of the device (for example linear or nonlinear, oscillation or vibration, shaking, uniform or non uniform movement. The predefined functionalities assigned to predefined poses are specific commands to the device. The predefining of the initial poses comprises direct data values (for example battery level, orientation of the device, etc.) and data derived from the direct data values (For example if orientation changes fast the device is being shaken. If GPS changes fast the user of mobile or wearable device is in transportation vehicle, etc.). Therefore, some of the values of an initial pose are direct inputs from the user's device (e.g. orientation, shaking of the device) and other values are circumstantial. The values chosen by the user are the key of the present invention, because the chosen values give the user the ability of selecting an initial pose (shake the device, put it vertical, etc.) before activating the trigger. As the user knows the possible initial poses, the selection of a pose is equivalent to the selection of a command to the device (type this letter, create a mouse pointer on the screen, switch off the TV, etc.).

The activation trigger is for example a button on the device, a software function, the starting moment of a data streaming or any other method, function or command initiated by the user, by the device itself or by an external interaction.

The present invention is explained more precisely with following drawings.

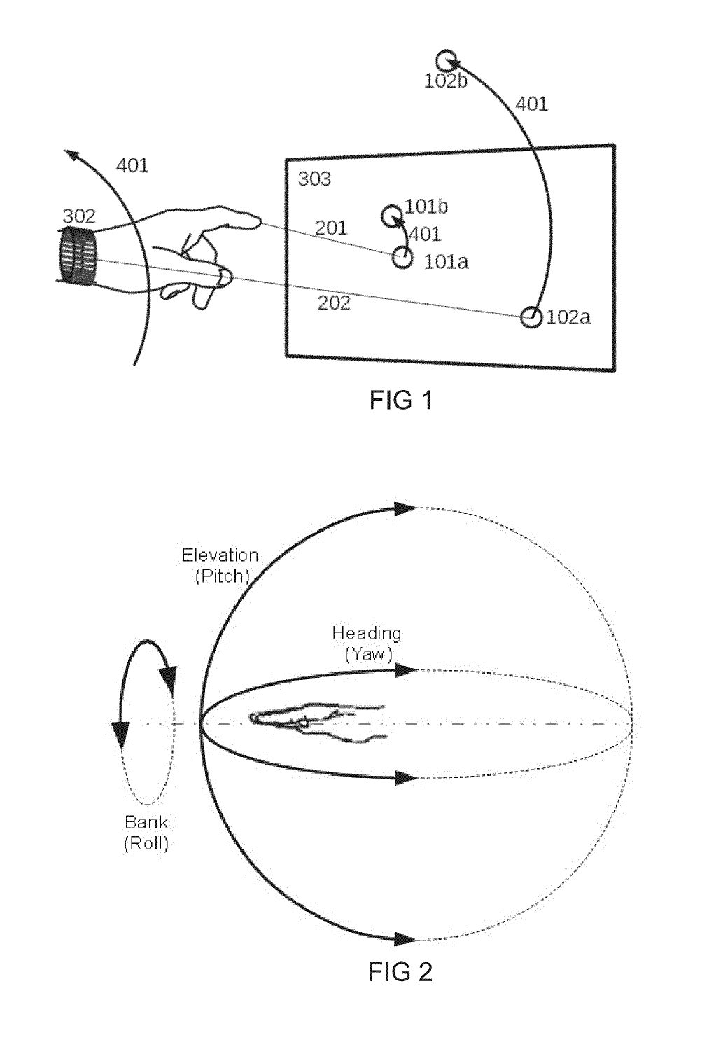

FIG. 1 illustrates the problem known from prior art wherein the user, wearing a wristband 302 points to a screen 303. The user is using his finger to point on the direction 201, but the wristband is actually using the direction 202 as a pointing reference. When the user twist his hand 401 around his pointing finger, he expect the dot 101a to do not move, but because of his human body is not accurate on that task, the dot will move to position 101b. In addition, because of the wristband reference direction is slightly different, the same turn will move the dot 102a to the position 102b.

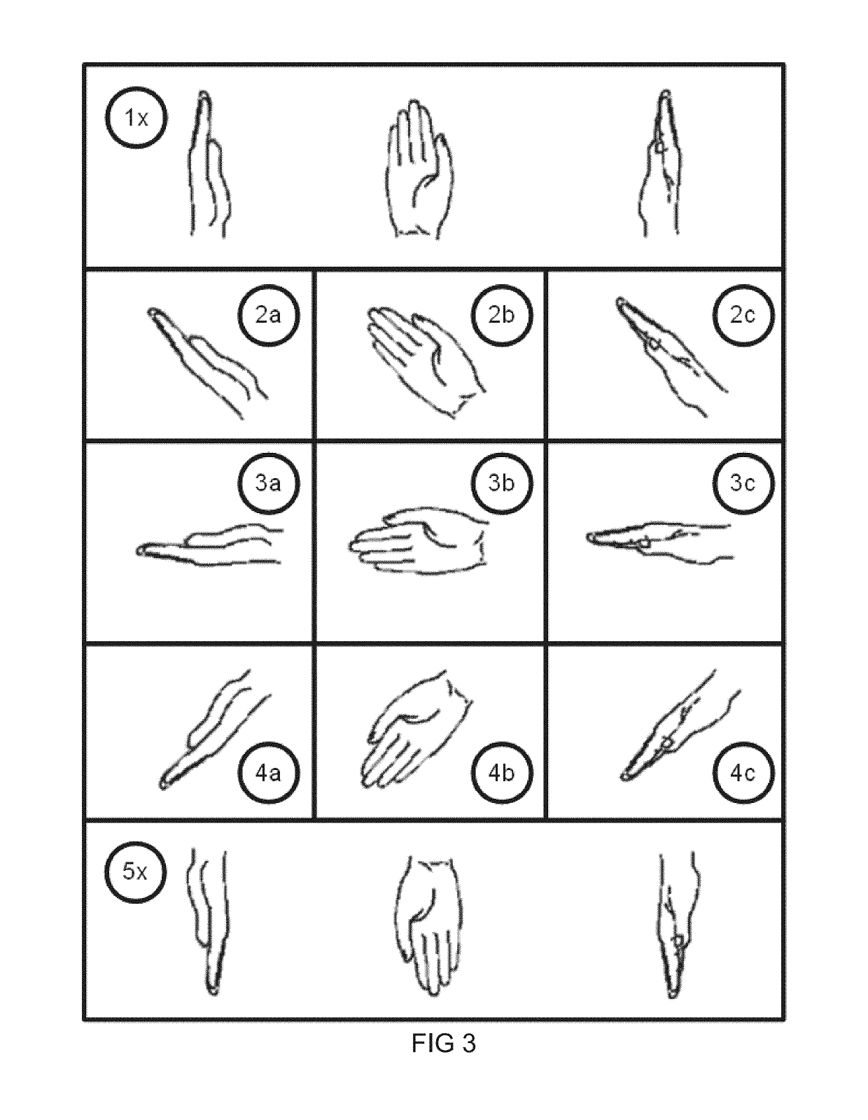

FIG. 2 explains Elevation-Heading-Bank coordinates system, also called Tait-Bryan angles, Cardan Angles, Nautical angles or Yaw-Pitch-Roll, which is used in the method according to present invention. For properly fixing the reference system to the mobile or wearable device in a way that the values of the parameters (Elevation-Heading-Bank) have a physical meaning directly related to the orientation and movements of the device (user interaction), first it is required to define a pointing direction on the device and a reference (starting values) for the Bank (roll) and Heading (Yaw). All these parameters may be fixed by the target system, by the user or dynamically changed by any algorithm. For example, if the user wants to use his hand as an air-plane, the direction of the fingers could be the pointing direction and the palm of the hand facing down could be the zero-reference for the Bank (roll). Doing so, the angle of the fingers with the floor would be the Elevation (from −90 to 90 degrees) and the angle that the fingers turns in the horizontal plane would be the Heading (Yaw). As it is well known, this coordinates system is affected by the gimbal lock and therefore inconvenient for defining orientations where Elevation is near vertical, because on that circumstance the Heading and Bank become uncertain/undefined. At this point it is important to underline that the present method do not discuss which algorithm is used for tracking the orientation (for different applications and circumstances, different algorithms may be used, if necessary). The present method focuses on the user interaction and the usage of the data, however it has being obtained.

The Elevation-Heading-Bank system is used in the present method in several following ways:

Accurate Elevation in every circumstance: As accelerometer use to be the basic sensor and the accuracy on the ground direction is strongly trustful for a handheld device (as long as the hand is not strongly shaking), the Elevation value can be used as accurate input data.

Accurate Bank: as long as the elevation is not near-vertical, the calculation of the Bank is also accurate and do not accumulate any errors.

Repeatability: if the device is on certain orientation, it moves and shakes and then go back to the same orientation, both Elevation and Bank will have the same values than before. Heading could have drifted and accumulated errors, especially if there is no magnetometer to compensate them. Even with magnetometer, if the user is moving inside a building, sitting in a moving train or other circumstances, Heading may be affected, but not Elevation and Bank.

Instant translation into a virtual Joystick: Elevation can be used as a reference of the front-back movement of a virtual joystick and the Bank for the right-left movement. No extra conversions or calculations are required.

Instant Access to Elevation and Bank values: Even if the device is in sleep mode and IMU sensors disconnected, activating a trigger it is possible to wake up accelerometer and obtain, in milliseconds, the value of the Elevation and Bank. (Only accelerometer is required for all the previous cases, so this is possible even in extremely simple wearables without gyroscope).

Instant translation into a screen pointer: Elevation can be used as a reference of the vertical movement on a screen and the Heading for the horizontal movement. No extra conversions or calculations are required.

Absolute or relative values. Depending on the application, could be interesting, for example, to use a relative Heading value that can be reset dynamically to avoid drift or other errors while using absolute or relative Elevation and Bank indistinctly.

Smooth twists (virtual dial manipulation). As explained before, if the user tries to twist the device around a pointing direction, he will be quite accurate on the turned angle (the Bank) but will fail to keep the same pointing direction (will change the Heading and Elevation accidentally). Just adding an offset variable to the Elevation and Heading it is instant to fix the values of Elevation and Heading during the twist movements. The result is that when the user twist his hand or activates any possible trigger, the Heading and Elevation can be frozen and the Bank value can be used as an accurate input. This match perfectly with a use case where the user pick up in the air a virtual dial and turns clockwise or counterclockwise for adjusting a value, like the volume of a music player, for example.

FIG. 3 illustrates some examples of orientations according to the present invention defined by Elevation (1,2,3,4,5) and Bank (a,b,c). As explained before, for vertical orientations (1&5) the Bank is undefined. These orientations can be easily understood by the user and may be used as starting orientations for different functionalities. For example, starting on 2b and moving to 2a-2c (changing the Bank angle) may be regulating the music volume.

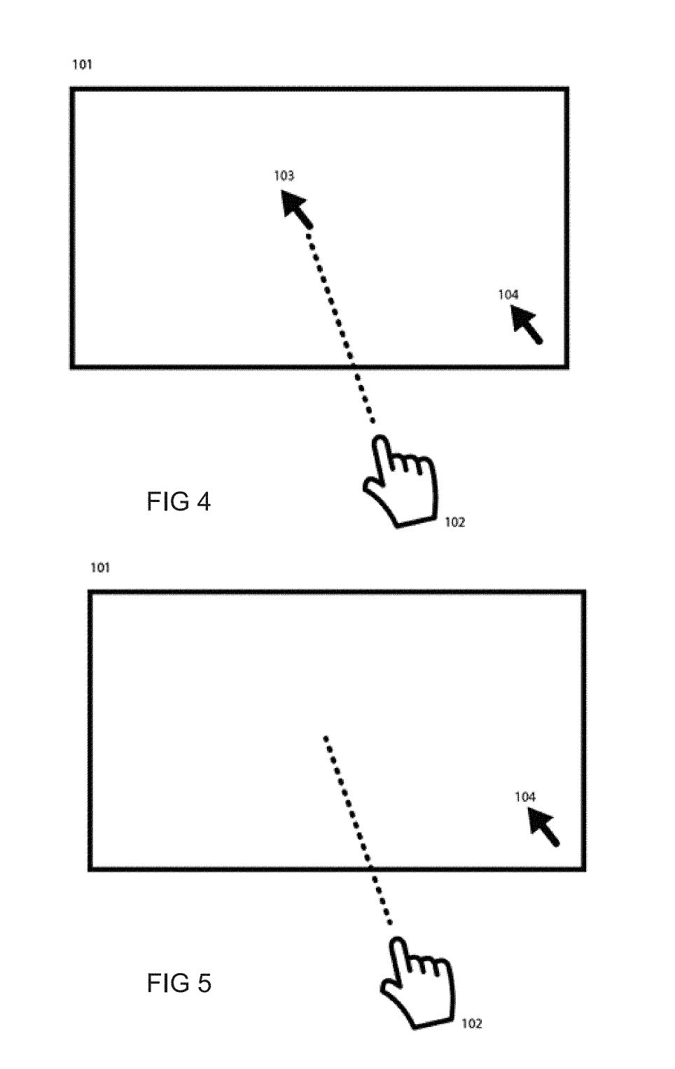

FIG. 4 illustrates the drift problem from prior art, if user wearing smart wristband 102 points to screen 101 it is expected to see cursor in location 103 which is intuitive, not location 104, for example.

According to the present invention the drift eliminating is carried out, when user detects drift of comfort window, by moving limb or other body part wearing sensor to edge of comfort window. It may or may not include haptic, visible or audible feedback to user.

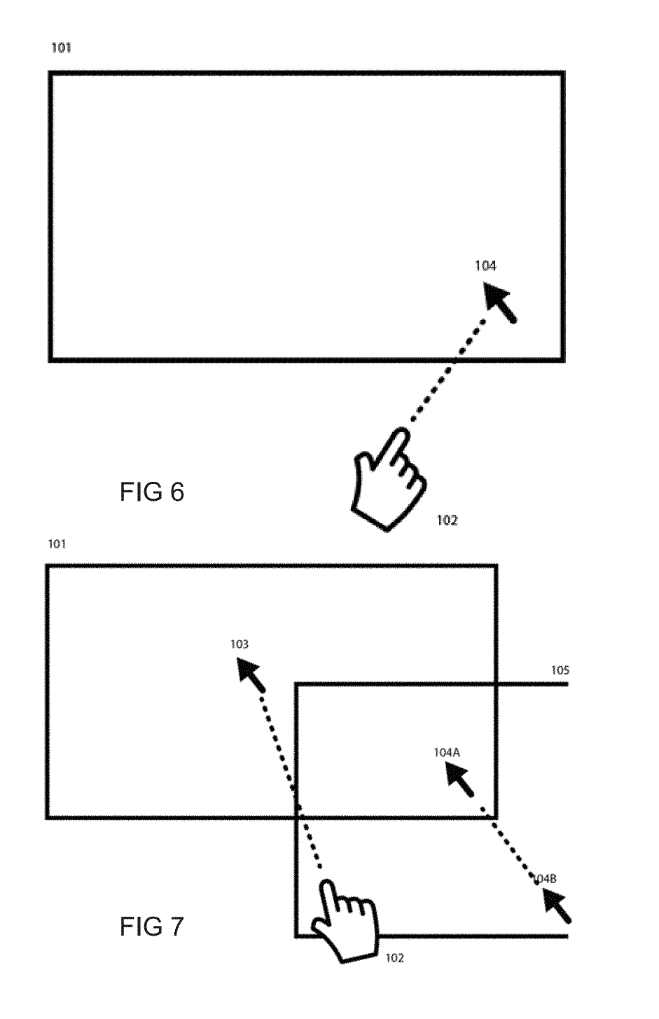

FIG. 5 and FIG. 6 illustrate the present invention, for example if user 102 points to screen 101, then cursor MAY appear at location 104 because of different uncertainties and drift. User can easily and intuitively come out of situation by moving hand into new position as shown on image FIG. 6. This behavior is known from computer mouse. If cursor hits the border, sensor can be moved more and more further but cursor remains at edge of screen.

FIG. 7 describes the present invention more specifically. According to present invention such “screen border” is applied in real world. For wearables, there is no strict physical screen but comfort window of limb or body movement. In this embodiment, the initial poses of miniature wearable device (for example smart ring or jewelry) is predefined and functionalities associated to the initial poses are predefined to configure the user's device. To eliminate the drift, the predefined poses are adopted to associated functionalities, for example the movement, orientation and pose of miniature device corresponds to cursor movements on screen and associated commands and functions, for example select, click, drag, drop, scroll, move back and forward while surfing in internet or browsing media, display or hide the cursor, type letters and punctuation marks.

On FIG. 7 105 marks actual comfort zone for user and 101 is erroneous location of comfort window as understood by wearable device (or device which uses wearable as input sensory). When the trigger is activated and corresponding signal is obtained, the user manipulates cursor 104A right-lower using limb which is carried out by using the first values of acquired data from the sensor of user's miniature wearable device to detect the initial pose and to determine the functionality according to the predefined initial pose. Because cursor instantly hits border of comfort window 101 known for wearable, window location is adjusted accordingly by formatting the data for this functionality. When user manipulates cursor from 104A to 104B, window 101 location is adjusted to new location 105. To ensure better user experience this process provide feedback to user—visual, haptic or other.

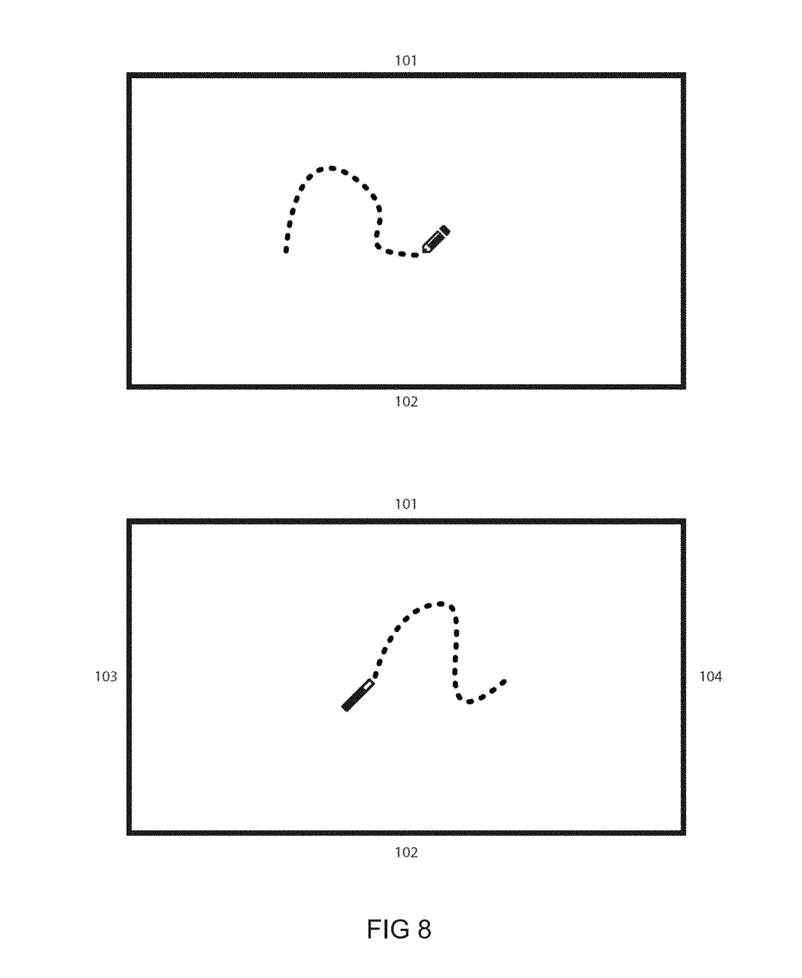

On FIG. 8 it is assumed that user wants to use pencil tool to draw line on screen. Moving limb on X and Y axes user can draw line (while trigger is activated, for example).

Pressing single button (or any other trigger) activates drawing, releasing button (or any other trigger) makes pencil move around freely without drawing. In existing user interfaces, extra menu is displayed to allow user to select eraser and other tools.

Current invention adds function of tool selection to borders of screen or any other realm user is working in. For example, user can move cursor up and touch border 101 to select pencil, make drawings and then touch border 102 to select eraser. This can be applied to any border or any corner of screen or any other realm of user. For example wearable devices like VR headsets can use turning head left, right, up or down to activate same functionalities. User may get or not get feedback about selected tool. It can be changed shape of cursor, audible signal or haptic feedback.

1. A gesture control method for interacting with a mobile or wearable device using a stream of sensor data as input data comprising steps of configuration of a user's device and drift eliminating wherein configuration of the user's device comprises
predefining set of initial poses of the user's device;
predefining commands and functionalities of user's device associated to said initial poses;
and drift eliminating comprises
adopting each predefined initial pose for a desired functionality;
obtaining a signal of trigger activation;
acquiring data from at least one sensor of user's device;
using first values of the sensor data as input data to detect the predefined initial pose;
determining the desired functionality according to the predefined initial pose;
formatting the data for said desired functionality;
interpreting rest of values of the input data stream according to said desired functionality.

2. The method according to claim 1, wherein the trigger activation is a function.

3. The method according to claim 1, wherein the trigger activation is a command initiated by the user.

4. The method according to claim 1, wherein the trigger activation is a command initiated by device itself.

5. The method according to claim 1, wherein the trigger activation is a command initiated by an external interaction.

6. The method according to claim 1, wherein acquiring input data comprises numeric values representing quantifiable parameters related to the mobile or wearable device use.

7. The method according to claim 1, wherein the rest of the input data is managed by different functions.

8. The method according to claim 1, wherein the rest of the input data is managed by the same function but with different parameters.

9. The method according to claim 1, wherein the rest of the input data is ignored.

10. A method for interacting with mobile or wearable devices using a stream of sensor data as input data comprising steps of
configuration of user's mobile or wearable device
predefining a set of initial poses of the device;
predefining functionalities associated to those initial poses;
adopting the initial pose for a desired functionality;
activating a trigger;
acquiring data from sensors;
using the first values of the data to detect the initial pose;
determining the desired functionality according to the initial pose;
formatting the data (if required) for that desired functionality;
interpreting rest of the input data stream according to that desired functionality.

11. The method according to claim 10, wherein the trigger activation is a function.

12. The method according to claim 10, wherein the trigger activation is a command initiated by the user.

13. The method according to claim 10, wherein acquiring input data comprises numeric values representing quantifiable parameters related to the mobile device use.

14. The method according to claim 10, wherein the rest of the input data is managed by different functions.

15. The method according to claim 10, wherein the rest of the input data is managed by the same function but with different parameters.

16. The method according to claim 10, wherein the rest of the input data ignored.
